(19) United States
(12) Patent Application Publication
(10) Pub. No.: US 2017/0256830 A1
(43) Pub. Date: Sep. 7, 2017

(54) THERMAL MANAGEMENT SYSTEM OF BATTERY PACK

(71) Applicant: CONTEMPORARY AMPEREX TECHNOLOGY CO., LIMITED, Ningde City (CN)

(72) Inventors: Zhijun QIU, Ningde City (CN); Ruobo YOU, Ningde City (CN)

(73) Assignee: CONTEMPORARY AMPEREX TECHNOLOGY CO., LIMITED, Ningde City (CN)

(21) Appl. No.: 15/336,169

(22) Filed: Oct. 27, 2016

(30) Foreign Application Priority Data
Mar. 7, 2016 (CN) 201610126928.3

(51) Int. Cl. H01M 10/617; H01M 10/6551; H01M 10/6557; H01M 10/625

(52) U.S. Cl. CPC H01M 10/617; H01M 10/625; H01M 10/6551; H01M 10/6557; H01M 2220/20; B60K 2001/005

(57) ABSTRACT

The present application relates to a thermal management system of a battery pack, which includes a battery pack and a cooling device of the battery pack, the battery pack includes a plurality of single batteries, the cooling device of the battery pack includes cooling fins and uniform temperature plates, the uniform temperature plates are arranged outside the batteries. This application has the following beneficial effect: uniform temperature plates are arranged between single batteries, cooling fin in accordance with the single batteries are arranged on outer surfaces of two sides of the uniform temperature plate, such cooling structure adopts the existing module structure and volume of battery pack, meanwhile improving the heat dissipation effect of the battery pack, and reducing the battery temperature to a lower level than that of the existing wind cooling module, which is cost and time efficient with simple structure and simple procedure.

### TECHNICAL FIELD

The present application relates to the technical field of batteries, in particular, relates to a thermal management system of a battery pack.

### BACKGROUND

For the problem of energy crisis and environmental pollution becoming more and more serious, battery electric vehicle and hybrid electric vehicle emerge as the times requirement become as important means of transportation. Furthermore, battery is the energy carrier of battery electric vehicle and hybrid electric vehicle. In order to meet the requirements of fast charge and cruising distance, the battery must have high power density and high energy density. In order to guarantee the high power density and large energy density of batteries, usually a module composed of a large number of single batteries which through the manner of series connection or parallel connection. During the process of fast charge and large current discharge of module or pack, each single battery will generate lots of heat, as the heat constantly accumulate leads to the battery temperature increases sharply. And more, since the location of each battery is different, and the heat dissipation condition is quite different, which leads to serious non-uniform temperature distribution between batteries. However, most of the power batteries have much strict requirements on operating temperature. In the condition of high temperature, thermal runaway of the battery may possibly occur, which may lead to security incidents, such as smoking, fire, exploding and so on. In addition, the long-time non-uniform temperature distribution will greatly reduce battery service life. In the prior art, liquid cooling system and air cooling system are used to adjust battery temperature. Similar as heat exchanger, either liquid cooling system or air cooling system is to add a cooling device into battery pack.

Chinese invention patent No. 103715473 discloses a thermal management system for battery pack, radiator and fan of thermal management system are installed on the outside surface of the battery box. One or more heat tubes are inserted into the gap between adjacent battery packs. When battery temperature is higher than setting temperature, the liquid circulating pump and fan receive a starting signal, a side of semiconductor heating/refrigerating component clinging to the liquid box begins to refrigerate, so as to cool the circulating liquid in the liquid box, the liquid circulating pump pumps the cooled circulating liquid into a liquid circulating pipe, and then quickly exchange heat through the heat pipe clinging to the liquid flow plate to cool the battery pack. When one side of semiconductor heating/refrigerating component refrigerates liquid box, another side will generate a great amount of heat, the generated heat passes to a heat conducting surface of the heat radiator which tightly clinging to the other side of the semiconductor heating/refrigerating component, the heat conducting surface passes the heat to the side of a cooling fin, through the fan at the outside of the cooling fin blowing air to flow fast, the heat will be radiated to the air out of the battery box.

In the prior art, water cooling and air cooling is the most common cooling method of the battery pack. The air cooling occupies a relative large volume in the battery pack and the cooling effect of the air cooling is unsatisfactory. The main reason is that the convection heat transfer coefficient of the battery surface is very low and the area of heat transfer is limited by the surface area of batteries, in order to carry off the heat of batteries by air, the battery temperature must be increased and higher than air temperature, which is quite unfavorable to battery service life and charge retention capacity. Therefore, a new thermal management system of battery pack needs to be provided to overcome the above mentioned defects.

### SUMMARY

Objective of the present application is to provide a thermal management system of a battery pack, which guarantees the cooling effect and is convenient for mass-production, meanwhile complying with the trend of miniaturization.

Objective of the present application is implemented by the following technical solution:

A battery pack thermal management system including a battery pack and a cooling device the battery pack includes several single batteries, characterized in that: the cooling device of the battery pack includes a cooling fin and a uniform temperature plate, the uniform temperature plate is arranged between these several single batteries and cooling fin is outside the single battery.

Further, the cooling fin is arranged on the single battery, and the cooling fin is arranged on surfaces of two sides of uniform temperature plate which along thickness direction of the single battery.

Further, all batteries are transversely arranged in parallel along thickness direction, and the single batteries are arranged separately along the thickness direction, so that a gap exists between the single batteries which used to embed the uniform temperature plate.

Further, thermal conductive adhesive is provided between the single battery and the uniform temperature plate, and a bonding connection is achieved between the uniform temperature plate and the single battery through the thermal conductive adhesive.

Further, fins are arrayed along thickness direction of the cooling fin extending and arranged along length direction of cells, the fins are arranged separately, and a gap exists between adjacent fins.

Further, the cooling fin and the uniform temperature plate cooperate with each other by welding, bonding or threaded connection.

Further, the uniform temperature plate is a hollow metal plate, an inner wall surface of the metal plate of the uniform temperature plate is covered by capillarity structure, and a supporting structure is provided between the metal plates for strengthening.

Further, the capillarity structure is processed by welding or bonding on the inner surface of the metal plate, or machined on the inner surface of the metal plate.

Further, interior metal plate of the uniform temperature plate is filled with liquid working medium after being vacuumed.

Further, the battery pack also includes an end plate arranged outside the single battery along thickness direction, structural adhesive is provided between the end plate and battery, and the end plate cooperate with the battery through structural adhesive.

Comparing to the prior art, the present application has the following beneficial effect: a uniform temperature plate is arranged between batteries, a cooling fin in accordance with battery is arranged on outer surfaces of two sides of the uniform temperature plate, such cooling structure adopts the existing module structure and volume of battery pack, meanwhile improving the heat dissipation effect of the battery pack, and reducing the battery temperature to a lower level than that of the existing wind cooling module, which is cost and time efficient with simple structure and procedure.

### BRIEF DESCRIPTION OF DRAWINGS

FIG. 1 is the perspective combination view of the battery pack thermal management system according to the present application.

FIG. 2 is the front view of the battery pack thermal management system according to the present application.

Reference signs of main components:

| | | | |
|---|---|---|---|
| thermal management system of | 100, | Battery pack | 1, |
| battery pack | | | |
| End plate | 10, | Single battery | 11, |
| Cooling device of battery pack | 2, | Cooling fin | 21, |
| Fin | 211, | Through hole | 212, |
| Uniform temperature plate | 22. | | |

The present application will be illustrated in more details by the following embodiments with reference to the accompany drawings.

### DESCRIPTION OF EMBODIMENTS

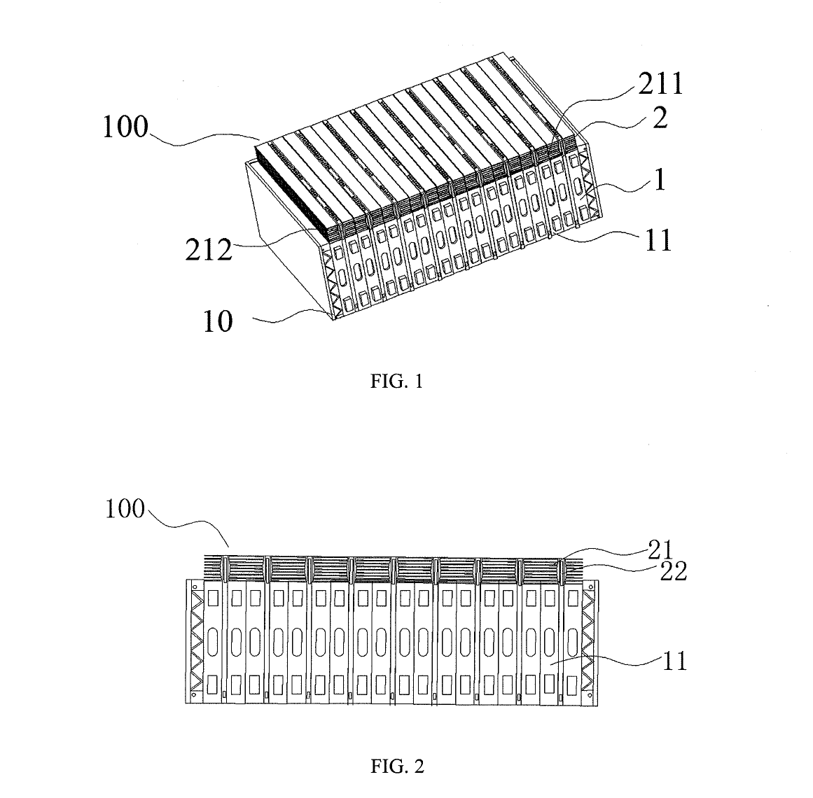

Hereinafter, embodiments of a battery pack thermal management system 100 according to the present application will be introduced referring to FIG. 1 and FIG. 2. The thermal management system 100 of the battery pack includes a battery pack 1 and a cooling device 2 which arranged together with battery pack 1.

As shown in FIG. 1, battery pack 1 includes several single batteries 11 with the same appearance, and an end plate 10 arranged at two sides thereof. Define the length, width and thickness of single battery 11, and define the length direction, the width direction and the thickness direction of the single battery 11.

As shown in FIG. 1 and FIG. 2, tall single batteries 11 are transversely arranged in parallel along thickness direction, and each single battery 11 is of substantially a cuboid structure. The single batteries 11 are arranged separately in the thickness direction, so that a gap exists between each two single batteries 11, so as to embed uniform temperature plates 22 therein.

End plate 10 is arranged at the outside of single battery 11 along the two sides of thickness direction. Structural adhesive is provided between the end plate 10 and outer side of battery 11. End plate 10 and single battery 11 are bonded and cooperated through the structural adhesive.

In an embodiment of the present application, there are eighteen single batteries 11, the two single batteries 11 on outer side is bonded with end plates 10 at two sides, the sixteen single batteries 11 in the middle form eight modules in pairs, a uniform temperature plate 22 is provided between the eight modules.

The cooling device 2 of battery pack includes a plurality of cooling fins 21 and uniform temperature plates 22. The cooling fin is arranged at the outside of the uniform temperature plate 22, preferably, the cooling fin 21 is arranged on the battery 11. Cooling fin 21 is a metal fin structure commonly used in the field, which is provided with a fin 211 extending along thickness direction and arranged alone length direction. Fins 211 are arranged separately, and a gap exists between adjacent fins 211. A plurality of cooling fins 21 are arranged on each single battery 11, cooling fin 21 is connected with the upper portion of the uniform temperature plate 22, the connection manner can be referred to any available mechanical connection manner, which can be welding or bonding, and can also be threaded connection.

The lower portion of the uniform temperature plate 22 is arranged between batteries 11, and each two batteries 11 share one uniform temperature plate 22. Thermal conductive adhesive is provided between the lower portion of the batteries 11 and uniform temperature plate 22. Moreover a bonding connection is achieved between the uniform temperature plate 22 and batteries 11 through the thermal conductive adhesive.

The uniform temperature plate 22 is a hollow metal plate. The inner wall surface of the uniform temperature plate 22 is capillary structure, and a supporting structure is provided between metal plates for strengthening effect. The connection manner of the capillary structure can be referred to the connection manner of heat pipe in prior art or commonly used in industry, the capillary structure can be welded or bonded on the inner surface of the metal plate, and can also be machined on the inner surface of the metal plate. The interior of the mental plate of the uniform temperature plate 22 is filled with a certain amount of fluid working medium after being vacuumed. The fluid working medium changes phase and absorbs heat in the evaporation area, so as to change from liquid state to gas state, then flows to a cooling end due to pressure gradient. The fluid working medium changes phase again after cooling and releasing heat at the cooling end, so as to change from gas state to liquid state, and then comes back to the evaporation area by the capillary force of the capillary structure.

In the implementing manner of the present application, surfaces of two sides along the thickness direction of the uniform temperature plate 22 is welded with a cooling fin 21, a specialized air flue, that is, a through hole 212 is provided among the cooling fins 21. The size of the uniform temperature plate 22 is 60 mm*160 mm, the thickness is less than 5 mm, so as to take full advantage of the width between the single batteries 11 of the present application.

The cooling process of the present application is as follows: when the evaporation end is heated, the working medium at the evaporation end will be evaporated from liquid phase to gas phase, the gas phase medium reaches the cooling end through the hollow pipeline for the air pressure, the gas phase working medium changes into liquid phase after cooling in the cooling end, then the liquid phase working medium in the cooling end flows back to the evaporation end for the capillary effect, the working medium in the evaporation end changes from liquid phase to gas phase again, thereby achieving internal recycling. In the implementing manner of the present application, such cooling structure adopts the existing module structure and volume of battery pack, meanwhile improving the heat dissipation effect of the battery, and reducing the battery temperature to a lower level than that of the existing wind cooling module.

The above described are only part of the embodiments of the present application, but not executional of them, any equivalent variations made by those skilled in the art to the technical solutions of the present application after reading the specification of the present application should be covered by the claims of the present application.

What is claimed is:

1. A thermal management system of a battery pack, comprising a battery pack and a cooling device of the battery pack, the battery pack comprises a plurality of single batteries, characterized in that: the cooling device of the battery pack comprises cooling fins and uniform temperature plates, the uniform temperature plates are arranged between the batteries, the cooling fins are defined outside the batteries.

2. The thermal management system of the battery pack according to claim 1, characterized in that: the cooling fins are arranged on the batteries, and the cooling fins are arranged on surfaces of two sides along thickness direction of the batteries on the uniform temperature plate.

3. The thermal management system of the battery pack according to claim 1, characterized in that: the plurality of single batteries are transversely arranged in parallel arrangement along thickness direction, and the single batteries are arranged separately along the thickness direction, so that a gap existing between the single batteries is obtained to embed the uniform temperature plate therein.

4. The thermal management system of the battery pack according to claim 1, characterized in that: thermal conductive adhesive is provided between the single battery and the uniform temperature plate, and a bonding connection is achieved between the uniform temperature plate and the single battery through the thermal conductive adhesive.

5. The thermal management system of the battery pack according to claim 1, characterized in that: fins are arranged on the cooling fin which extend along thickness direction and are arranged along length direction, the fins are arranged separately, and a gap exists between the adjacent fins.

6. The thermal management system of the battery pack according to claim 1, characterized in that: the cooling fin and the uniform temperature plate cooperate with each other through a manner of welding, bonding or threaded connection.

7. The thermal management system of the battery pack according to claim 1, characterized in that: the uniform temperature plate is a hollow metal plate, an inner wall surface of the metal plate of the uniform temperature plate is capillarity structure, and a supporting structure is provided between the metal plates for structural strengthening.

8. The thermal management system of the battery pack according to claim 7, characterized in that: the capillarity structure is formed by welding or bonding on the inner surface of the metal plate, or machined on the inner surface of the metal plate.

9. The thermal management system of the battery pack according to claim 8, characterized in that: interior of the metal plate of the uniform temperature plate is filled with liquid working medium after being vacuumed.

10. The thermal management system of the battery pack according to claim 1, characterized in that: the battery pack also comprises an end plate arranged outside the single battery along thickness direction of the battery pack, structural adhesive is applied between the end plate and its adjacent single battery, and the end plate cooperate with the single battery through the structural adhesive.
